(19) United States
(12) Patent Application Publication
(10) Pub. No.: US 2016/0074266 A1
(43) Pub. Date: Mar. 17, 2016

(54) CONVEYANCE ASSISTING DEVICE

(71) Applicant: KABUSHIKI KAISHA TOSHIBA, Tokyo (JP)

(72) Inventor: Hideichi NAKAMOTO, Tokyo (JP)

(21) Appl. No.: 14/847,689

(22) Filed: Sep. 8, 2015

(30) Foreign Application Priority Data
Sep. 16, 2014 (JP) 2014-187569

(51) Int. Cl. A61G 7/10

(52) U.S. Cl. CPC A61G 7/1001

(57) ABSTRACT

According to one embodiment, a conveyance assisting device includes a main body, an object support part, a main body support part, a foot part, and a connecting part. The main body is to be worn by a user. The object support part is connected to the main body, and is used to support an object to be conveyed. The main body support part supports the main body. The foot part is connected to the main body support part, and is movable along a traveling surface. The connecting part connects the main body support part and the foot part to each other such that a position of the foot part relative to the main body support part is changed according to a direction and a magnitude of force acting on the main body support part.

### CROSS-REFERENCE TO RELATED APPLICATIONS

This application is based upon and claims the benefit of priority from Japanese Patent Application No. 2014-187569, filed Sep. 16, 2014, the entire contents of which are incorporated herein by reference.

### FIELD

Embodiments described herein relate generally to a conveyance assisting device.

### BACKGROUND

At a nursing care site or physical distribution site, there is a need for a conveyance assisting device that assists the conveyance of a physical object (particularly a heavy object). As the conveyance assisting device, for example, a device that singly carries out conveyance such as a lifter, and a wearable device that is to be worn on each joint of the user to assist the user in conveying an object are known. The lifter has a structure that is able to independently bear the entire load when standing, therefore it is large and the place of use thereof is limited. Besides, the lifter requires preparatory work for use. Accordingly, a lifter is not used in small spaces such as a sickroom, and at sites where various types of work other than lifting work intermingle with each other. On the other hand, the wearable device to be worn on each joint of the user restrains the joints of the user, and therefore disturbs the movement of the user in some cases.

It is very dangerous if the user of the wearable conveyance assisting device falls down while conveying an object. Accordingly, the wearable conveyance assisting device is required to include a fall-prevention mechanism that prevents the user from falling.

### BRIEF DESCRIPTION OF THE DRAWINGS

FIG. 1 is a perspective view showing a conveyance assisting device according to a first embodiment.

FIG. 2 is a view showing a state where the user wears the conveyance assisting device shown in FIG. 1.

FIG. 3A and FIG. 3B are a side view and top view illustrating an operation of the foot part shown in FIG. 1.

FIG. 4 is a side view illustrating an operation of the brake shown in FIG. 1.

FIG. 5A is a side view showing the conveyance assisting device according to the first embodiment in a state where the foot part is retracted.

FIG. 5B is a side view showing the conveyance assisting device according to the first embodiment in a state where the foot part is extended.

FIG. 6 is a block diagram showing a conveyance assisting device according to a modification example of the first embodiment.

FIG. 7A and FIG. 7B are a perspective view and side view each showing a conveyance assisting device according to a second embodiment.

FIG. 8A is a side view showing the conveyance assisting device according to the second embodiment in a state where the foot part is retracted.

FIG. 8B is a side view showing the conveyance assisting device according to the second embodiment in a state where the foot part is extended.

FIG. 9 is a block diagram showing the conveyance assisting device according to the second embodiment.

### DETAILED DESCRIPTION

According to one embodiment, a conveyance assisting device includes a main body, an object support part, a main body support part, a foot part, and a connecting part. The main body is to be worn by a user. The object support part is connected to the main body, and is used to support an object to be conveyed. The main body support part supports the main body. The foot part is connected to the main body support part, and is movable along a traveling surface. The connecting part connects the main body support part and the foot part to each other such that a position of the foot part relative to the main body support part is changed according to a direction and a magnitude of force acting on the main body support part.

Hereinafter, embodiments will be described with reference to the drawings. In the following embodiments, like elements are denoted by like reference symbols, and duplicated descriptions of them are omitted.

### First Embodiment

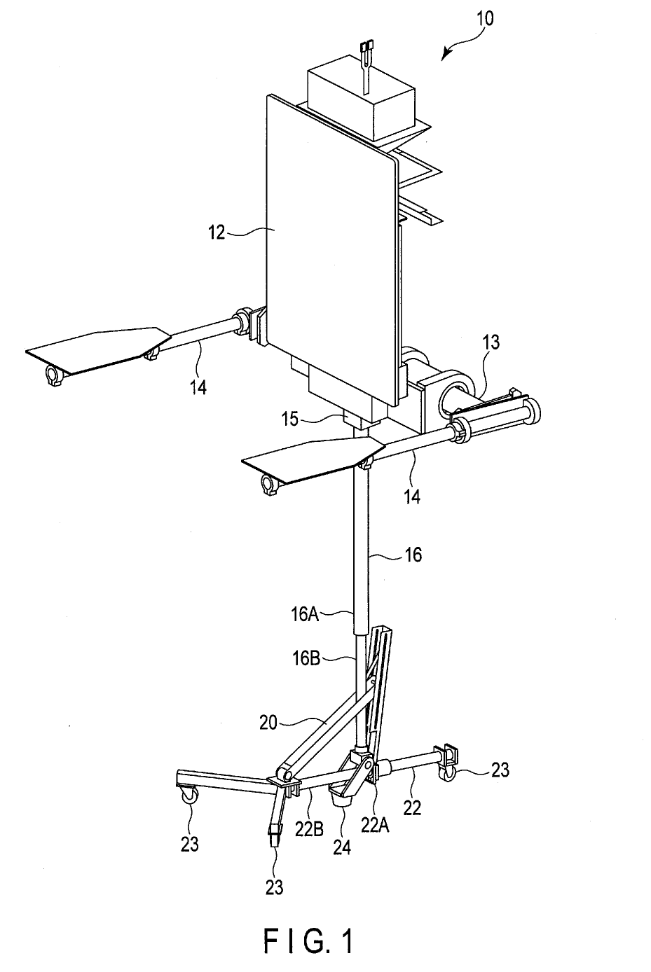

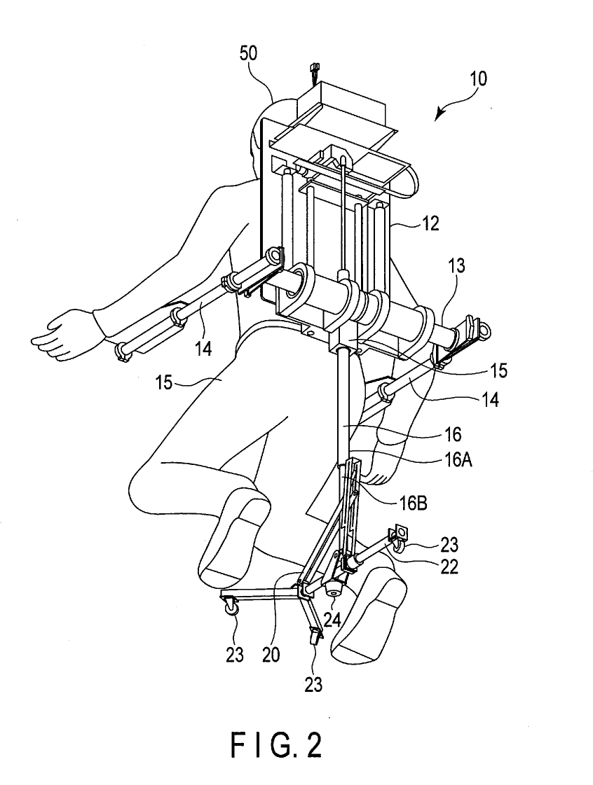

FIG. 1 schematically shows a conveyance assisting device 10 according to a first embodiment, and FIG. 2 schematically shows a state where the user 50 wears the conveyance assisting device 10. Hereinafter, the state where the user 50 wears the conveyance assisting device 10 is referred to as a worn state. The conveyance assisting device 10 is a device that assists the user 50 in conveying an object. The object is not limited to an inanimate object and, can be, for example, a human such as a person requiring nursing care. The conveyance assisting device 10 includes a main body 12 to be worn by the user 50. The main body 12 is attached to the back of the user 50. In FIG. 1 and FIG. 2, although an attaching implement for attaching the main body 12 to the user is not shown, a belt, for example, can be used as the attaching implement. A surface of the main body 12 positioned on the user 50 side in the worn state is called a front surface, and a surface of the main body 12 opposite to the front surface is called a back surface. Also, the side which the front surface of the main body 12 faces is called the front, and the side which the back surface of the main body 12 faces is called the back.

One or more (two in the example of FIG. 1) object support parts 14 to support an object to be conveyed are connected to the main body 12. For example, each of the object support parts 14 is connected to a support member 13 provided on the back surface of the main body 12 in such a manner that the object support part 14 protrudes toward the front surface side. In the worn state, a body of the user 50 is positioned between the object support parts 14, and the object support parts 14 are positioned at approximately the same height as the user 50's forearms in a state where the user bends his or her elbows at a right angle. In the present embodiment, the object support parts 14 support the object from below.

The conveyance assisting device 10 may include a drive unit (not shown) which drives the object support parts 14 in such a manner that the object support parts 14 are kept horizontal. By providing the drive unit, it is possible, when the user 50 loses his or her balance and the main body 12 inclines, to prevent the object from falling from the object support parts 14.

The main body 12 is supported by a main body support part 16 and a foot part 22. The main body 12 is connected to one end of the main body support part 16, and the foot part 22 is connected to the other end of the main body support part 16. For example, the main body support part 16 includes a first support member 16A fixed to a lower end of the main body 12, and a second support member 16B supported by the first support member 16A movable in a direction in which the first support member 16A extends. The second support member 16B is driven by a drive unit 15 provided on the main body 12. The drive unit 15 causes the second support member 16B to move longitudinally in such a manner that the foot part 22 is in contact with the traveling surface (for example, the ground surface or the floor surface). That is, the drive unit 15 adjusts a length of the main body support part 16 in such a manner that the foot part 22 is in contact with the traveling surface. The foot part 22 transmits the weight of the user 50, weight of the object, and tare weight of the conveyance assisting device 10 to the traveling surface. Thereby, the load to be applied to the user 50 can be reduced. A brake 24 is further connected to the second support member 16B. The brake 24 is described later.

The foot part 22 includes a stationary part 22A connected to a distal end of the second support member 16B, and a moving part 22B which is movable relative to the stationary part 22A. The foot part 22 is in contact with the traveling surface at three or more points, whereby the conveyance assisting device 10 can stand by itself on the traveling surface. In the example shown in FIG. 1, the moving part 22B includes three wheels (for example, casters) 23, and is in contact with the traveling surface at these three wheels 23. The conveyance assisting device 10 can move along the traveling surface by means of the wheels 23.

The moving part 22B is movably supported by the stationary part 22A, and is connected to the second support member 16B by a connecting part 20. The connecting part 20 connects the main body support part 16 and the foot part 22 to each other in such a manner that the position of the foot part 22 relative to the main body support part 16 is changed according to the direction and magnitude of the force acting on the main body support part 16. Specifically, the connecting part 20 connects the main body support part 16 and foot part 22 to each other in such a manner that the position of the foot part 22 relative to the main body support part 16 is changed according to the inclination of the main body support part 16 relative to the foot part 22. For example, when the user 50 loses his or her balance, and is on the verge of falling, the connecting part 20 pushes the moving part 22B of the foot part 22 in the corresponding direction. Thereby, the user 50 can be prevented from falling.

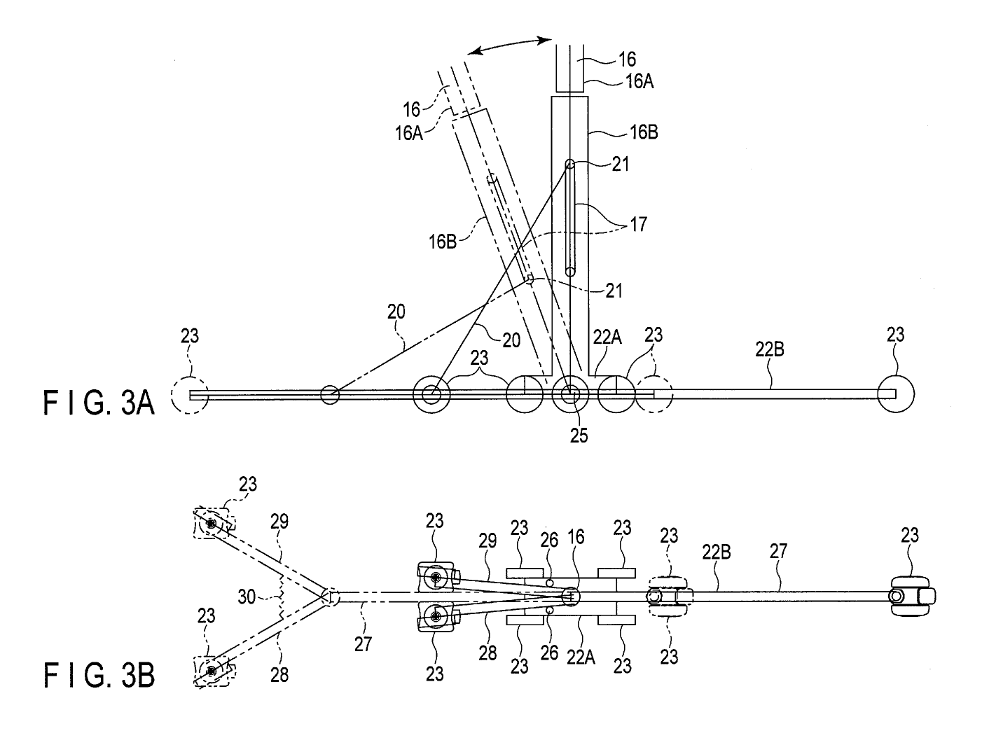

FIG. 3A and FIG. 3B are a side view and top view schematically showing the operation of the foot part 22 of the conveyance assisting device 10. In FIG. 3A and FIG. 3B, each element is shown in a simplified manner and, in addition, illustrations of some elements such as the brake 24 are omitted. Also, in FIG. 3A and FIG. 3B, the arrangement in a stable state where the user 50 keeps his or her balance is indicated by solid lines, and the arrangement in an unstable state where the user 50 loses his or her balance is indicated by two-dot chain lines. In the example shown in FIG. 3A and FIG. 3B, the foot part 22 includes seven wheels. More specifically, the stationary part 22A includes four wheels 23, and the moving part 22B includes three wheels 23.

As shown in FIG. 3A, the main body support part 16 is connected to the stationary part 22A of the foot part 22 through a rotating shaft 25, and can rotate, i.e. incline, toward the front around the rotating shaft 25. In the stable state, the main body support part 16 is perpendicular to the traveling surface and, in the unstable state, the main body support part 16 inclines relative to the direction perpendicular to the traveling surface. A slit 17 is formed in the second support member 16B. A pin 21 is provided at one end of the connecting part 20, and the pin 21 is connected to the slit 17 in such a manner that the pin 21 can slide along the slit 17. In the stable state, the pin is positioned at an upper end of the slit 17. The other end of the connecting part 20 is connected to the moving part 22B of the foot part 22. As shown in FIG. 3A, when the main body support part 16 inclines toward the front, the pin slides downward, whereby the connecting part 20 pushes the moving part 22B of the foot part 22 toward the front. In this way, it is possible to mechanically change the position of the foot part 22 in such a manner that the change is linked to the inclination of the main body support part 16.

When the position of the foot part 22 is changed, a base of support is changed. The base of support indicates a range formed by connecting the positions which are in contact with the traveling surface for the purpose of posture maintenance. Specifically, the base of support is an area on the traveling surface obtained by surrounding the soles of the feet of the user 50, and seven wheels 23. When a center-of-gravity point, obtained by projecting perpendicularly onto the traveling surface a center of gravity of a system constituted of the user 50, conveyance assisting device 10, and an object, is positioned inside the base of support, the user 50 can keep his or her standing posture. When the center-of-gravity point becomes positioned outside the base of support, the user 50 becomes unable to keep his or her standing posture. In the present embodiment, when the user 50 is about to fall toward the front, the main body support part 16 inclines toward the front correspondingly, and the moving part 22B of the foot part 22 is pushed toward the front. Thereby, the center-of-gravity point is maintained inside the base of support, and the user 50 can be prevented from falling. Furthermore, by providing an extension part that extends the foot part 22 in order to enlarge the base of support, it is possible to enhance the fall-prevention effect.

An operation of the foot part 22 will be described below with reference to FIG. 3B. The moving part 22B includes a first member 27, second member 28 and third member 29 which are connected to one end of the first member 27 in such a manner that the members 28 and 29 are pivotally rotatable, and spring 30 provided between the second member 28 and third member 29, and serving as an elastic member that imparts elastic force to the members 28 and 29 in a direction in which an angle formed between the second member 28 and third member 29 is increased. The stationary part 22A is provided with a guide 26 that guides the second member 28 and third member 29 in such a manner that the aforementioned angle is changed according to the position of the foot part 22 relative to the main body support part 16. The extension part is formed by the second member 28, third member 29, spring 30, and guide 26. Specifically, in a stable state, the second member 28 and the third member 29 are pinched by the guide 26, thereby making the aforementioned angle smaller. When the unstable state is brought about, and the moving part 22B is pushed toward the front, the second member 28 and the third member 29 are extended by the elastic force of the spring 30. Thereby, the base of support becomes larger, and hence the fall-prevention effect is enhanced. Also, in the stable state, the foot part 22 is positioned on the rear side of the user 50 in a closed state, and so the foot part 22 does not interfere with the feet of the user 50. That is, the foot part 22 does not become an interference to the user 50.

As described above, when the user 50 loses his or her balance, and is about to fall, by advancing the foot part 22 in the direction in which the user 50 is about to fall, the base of support is enlarged, and the fall can be prevented from occurring. The wider the base of support is, the more difficult it is for a fall to occur. However, when the foot part 22 is in an extended state, there is a greater possibility of the foot of the user 50 coming into contact with the foot part 22 when the user 50 works or moves. Accordingly, a mechanism that extends the foot part 22 into a spread state as the need arises is necessary, and the above configuration is effective.

The fall-prevention operation is to be carried out instantaneously and, when such an operation is to be realized by using an actuator, a high-power motor is required. In the present embodiment, the fall-prevention operation is carried out mechanically by utilizing the inclination of the main body support part 16, and therefore the actuator is not necessary. As a result, it is possible to realize a lightweight and compact conveyance assisting device 10.

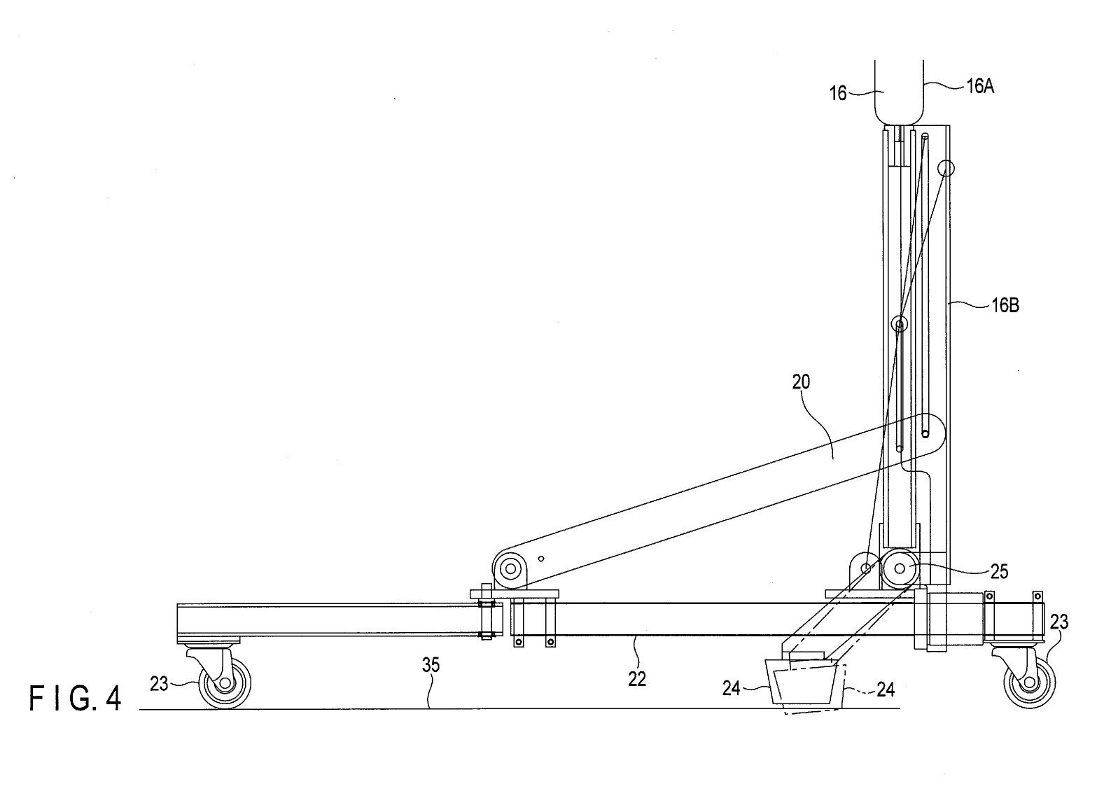

FIG. 4 is a side view schematically showing an operation of the brake 24 of the conveyance assisting device 10. In FIG. 4, the arrangement of the brake 24 in a stable state is indicated by solid lines, and the arrangement of the brake 24 in an unstable state is indicated by two-dot chain lines. During movement, it is required that the foot part 22 be able to move smoothly while supporting the weight. Conversely, while working, for example, when mounting an object on the object support part 14 or dismounting the object from the object support part 14, it is necessary that the foot part 22 should stop on the spot, and should not move even when force is applied thereto. The brake 24 comes into contact with the traveling surface according to the direction and magnitude of force acting on the main body support part 16. Specifically, the brake 24 comes into contact with the traveling surface according to the inclination of the main body support part 16 relative to the foot part 22. For example, concurrent with the rotation of the main body support part 16 around the rotating shaft 25, the brake 24 rotates around the rotating shaft 25. In the stable state, the brake 24 is at a brake release position at which the brake 24 is not in contact with the traveling surface, and the conveyance assisting device 10 can freely move along the traveling surface. When an unstable state is brought about, the position of the brake 24 changes to the braking position at which the brake 24 is in contact with the traveling surface, whereby braking is applied to the conveyance assisting device 10.

As described above, while working, it is possible to mechanically brake the conveyance assisting device 10 by inclining the main body support part 16. In the brake 24 as well, there is no need to provide an actuator. Thereby, it is possible to make the conveyance assisting device 10 lightweight and compact.

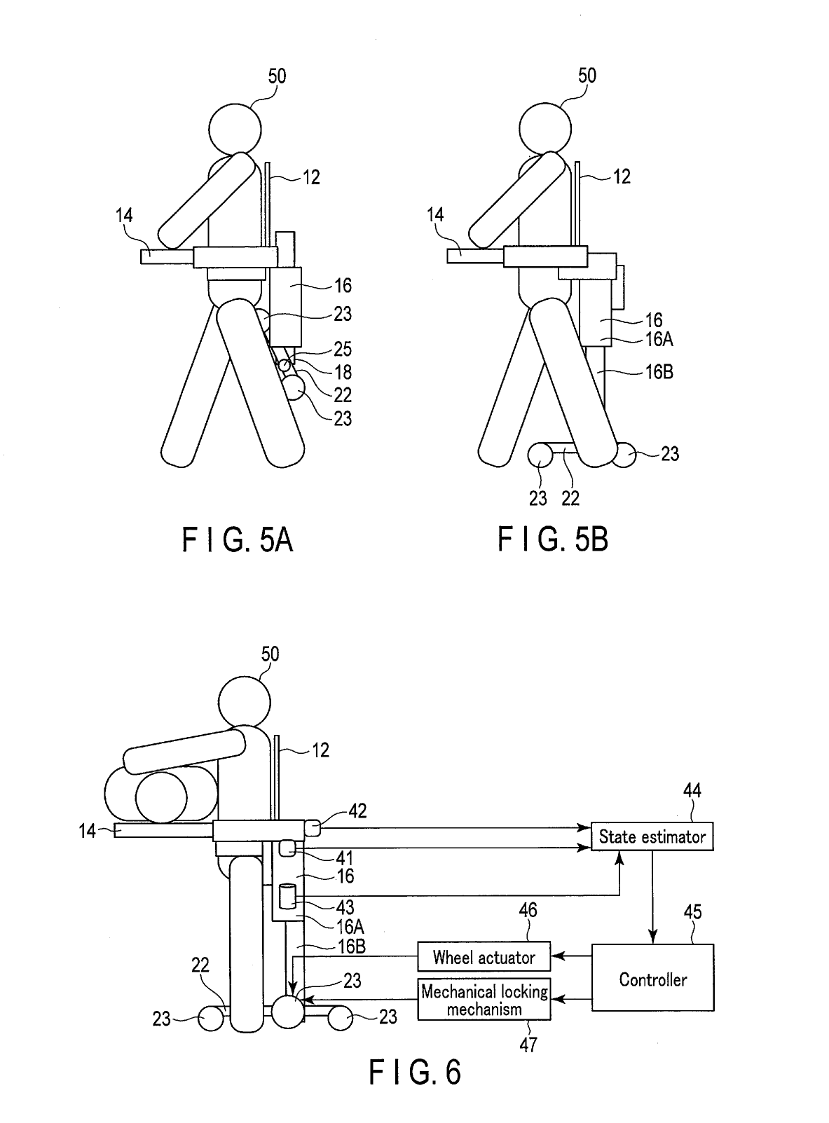

In the conveyance assisting device 10 of the present embodiment, the foot part 22 can be retracted in a compact form in order for the foot of the user 50 to not come into contact with the foot part 22 when the user 50 moves when not carrying out conveyance in the worn state. FIG. 5A schematically shows the conveyance assisting device 10 in a state where the foot part 22 is retracted, and FIG. 5B schematically shows the conveyance assisting device 10 in a state where the foot part 22 is extended.

As shown in FIG. 5A, in the state where the foot part 22 is retracted, the second support member 16B is shortened. The foot part 22 includes a spring (not shown) to add a turning force to the foot part 22 and, when no other force acts thereon, the foot part 22 is held in a posture in which the front wheels 23 of the foot part 22 are elevated by the spring. When transitioning from the foot part retracted state shown in FIG. 5A to the foot part extended state shown in FIG. 5B, the user 50 extends the second support member 16B. For example, when the user 50 operates a button, the drive unit 15 moves the second support member 16B in the downward direction. When the second support member 16B is extended, first the rear wheel 23 comes into contact with the traveling surface. When the second support member 16B is further extended, the foot part 22 rotates around the rotating shaft 25, bringing about a state where the front wheels 23 are also in contact with the traveling surface. When this state is brought about, locking is made in such a manner that the turning force of the spring does not act on the foot part 22.

When transitioning from the foot part extended state to the foot part retracted state, the user 50 shortens the second support member 16B. For example, when the user 50 operates a button, the drive unit 15 moves the second support member 16B in the upward direction. When the second support member 16B is shortened to a certain position, the locking is released, and the foot part 22 is held in a position in which the front wheels 23 thereof are elevated by the force of the spring.

As described above, in the conveyance assisting device 10 according to the first embodiment, the main body support part 16 and the foot part 22 are connected to each other by the connecting part 20 in such a manner that the position of the foot part 22 changes according to the direction and magnitude of the force acting on the main body support part 16. When the user 50 is about to fall, the connecting part 20 pushes the moving part 22B of the foot part 22 in the corresponding direction. Thereby, the user 50 can be prevented from falling. Furthermore, the foot part 22 is mechanically operated without use of an actuator. Thereby, it is possible to realize weight reduction and compactification of the conveyance assisting device 10.

FIG. 6 schematically shows a conveyance assisting device according to a modification example of the first embodiment. The conveyance assisting device shown in FIG. 6 includes a wheel actuator 46 which rotationally drives at least one of wheels 23, and mechanical locking mechanism 47 which locks at least one of the wheels 23.

An inclination sensor 41 and a distance sensor 42 are mounted on a main body 12. The inclination sensor 41 detects the inclination of the main body 12 relative to the traveling surface. The distance sensor 42 detects a distance between the main body 12 and traveling surface. An output of the inclination sensor 41 and an output of the distance sensor 42 are sent to a state estimator 44. Furthermore, a laser scanner 43 which detects a position of the user 50 by scanning the horizontal plane may be mounted on a main body support part 16. An output of the laser scanner 43 is sent to the state estimator 44.

The state estimator 44 estimates a state of the user 50 based on an output of at least one of the inclination sensor 41, distance sensor 42, and laser scanner 43. For example, the state estimator 44 determines whether the user 50 is working or is moving. A controller 45 controls the wheel actuator 46 and mechanical locking mechanism 47 based on the state estimated by the state estimator 44. For example, while the user 50 is working, the controller 45 controls the mechanical locking mechanism 47 to brake the wheel 23. Thereby, it is possible to make the device not move along the traveling surface to disturb the work of the user 50 that is working. In addition, while the user 50 is moving, the controller 45 carries out drive control of the wheel 23 to adjust to the walking speed of the user 50. Thereby, the user 50 can easily carry out conveyance/movement. Furthermore, when the positions of the user 50 and main body 12 deviate from each other, the controller 45 controls the wheel 23 to cancel out the deviation. Thereby, the user 50 can be prevented from falling. As described above, while the user 50 is moving, it is possible to prevent the user 50 from falling, and to carry out conveyance work more safely by utilizing the actuator 46 attached to the wheel 23.

### Second Embodiment

A second embodiment corresponds to an embodiment formed by modifying the first embodiment in such a manner that the foot part is positioned lateral to the user.

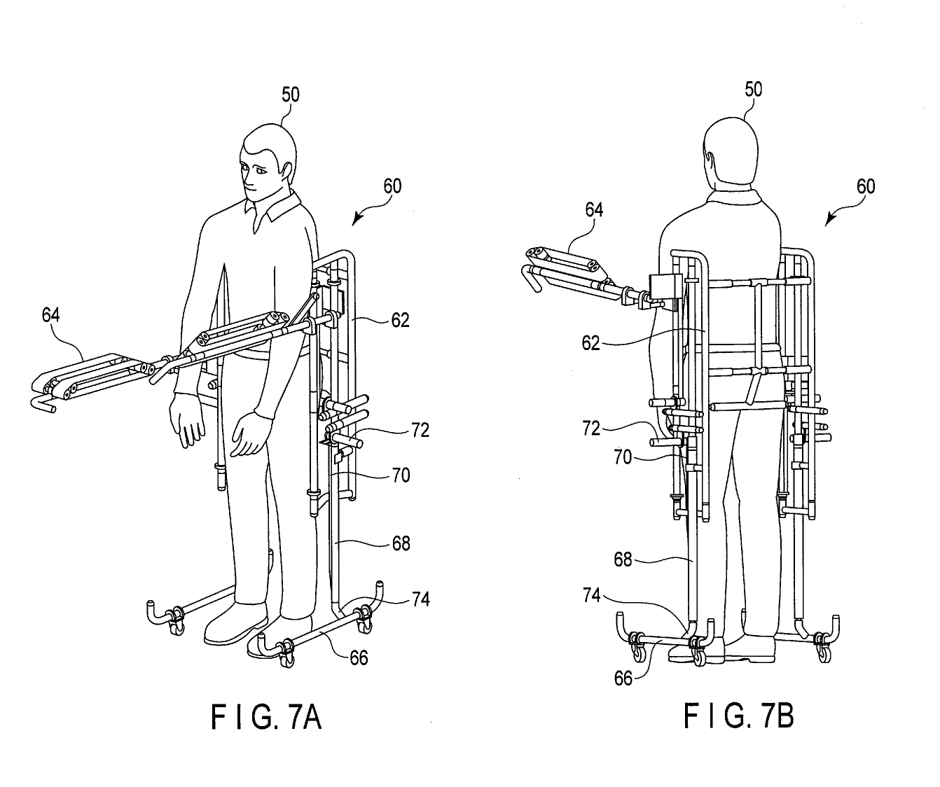

FIG. 7A and FIG. 7B are a perspective view and side view schematically showing a conveyance assisting device 60 according to a second embodiment. The conveyance assisting device 60 is a device that assists the user 50 in conveying an object. The conveyance assisting device 60 includes a main body 62 to be worn by the user 50. One or more (two in the example of FIG. 7A) object support parts 64 to support an object to be conveyed are connected to the main body 62. In the worn state, a body of the user 50 is positioned between the object support parts 64, and the object support parts 64 are positioned at approximately the same height as the forearms of the user 50 in a state where the user bends his or her elbows at a right angle.

The main body 62 is supported by a pair of main body support parts 70, and a foot part 66 is connected to each of the main body support parts 70. Each main body support part 70 includes a support member 68 movable in the vertical direction, and the support member 68 is driven by a drive unit 72 provided on the main body 62. The drive unit 72 drives the support member 68 in such a manner that the foot part 66 is in contact with the traveling surface. That is, the drive unit 72 adjusts the length of the main body support part 70 in such a manner that the foot part 66 is in contact with the traveling surface. The foot part 66 includes a plurality of (for example, two) wheels in order to move along the traveling surface. The foot part 66 transmits the weight of the user 50, weight of the object, and tare weight of the conveyance assisting device 60 to the traveling surface. Thereby, the load to be applied to the user 50 can be reduced. Although not shown in FIG. 7A and FIG. 7B, each of the main body support parts 70a may be provided with a brake identical to the brake 24 (FIG. 1) according to the first embodiment.

A connecting part 74 is provided between the foot part 66 and support member 68. The connecting part 74 connects the foot part 66 and support member 68 to each other to change the position of the foot part 66 relative to the main body support part 70 according to the direction and magnitude of the force acting on the main body support part 70 (specifically, the support member 68). More specifically, the connecting part 74 connects the foot part 66 and support member 68 to each other to change the position of the foot part 66 relative to the main body support part 70 according to the inclination of the main body support part 70 relative to the foot part 66. For example, when the user 50 loses his or her balance, and is about to fall, the connecting part 74 moves the foot part 66 in the corresponding direction. Thereby, the user 50 can be prevented from falling. In FIG. 7A and FIG. 7B, although the mechanism to change the position of the foot part 66 relative to the main body support part 70 is shown in a simplified manner, this mechanism can have a structure identical to the first embodiment.

In the present embodiment, the pair of main body support parts 70, the pair of foot parts 66, and the pair of connecting parts 72 are provided to produce a bilaterally symmetric appearance in order that they may be positioned outside the user 50. Thereby, it is possible to reduce the possibility of the foot of the user 50 coming into contact with the foot parts 66 while the user 50 is walking or working. As a result, it is possible to prevent the user 50 from falling due to the foot of the user 50 coming in contact with the foot part 66. Furthermore, the pair of foot parts 66 are provided in such a manner that they are positioned outside the feet of the user 50, and thus a larger base of support is secured. As a result, the fall-prevention effect is further improved.

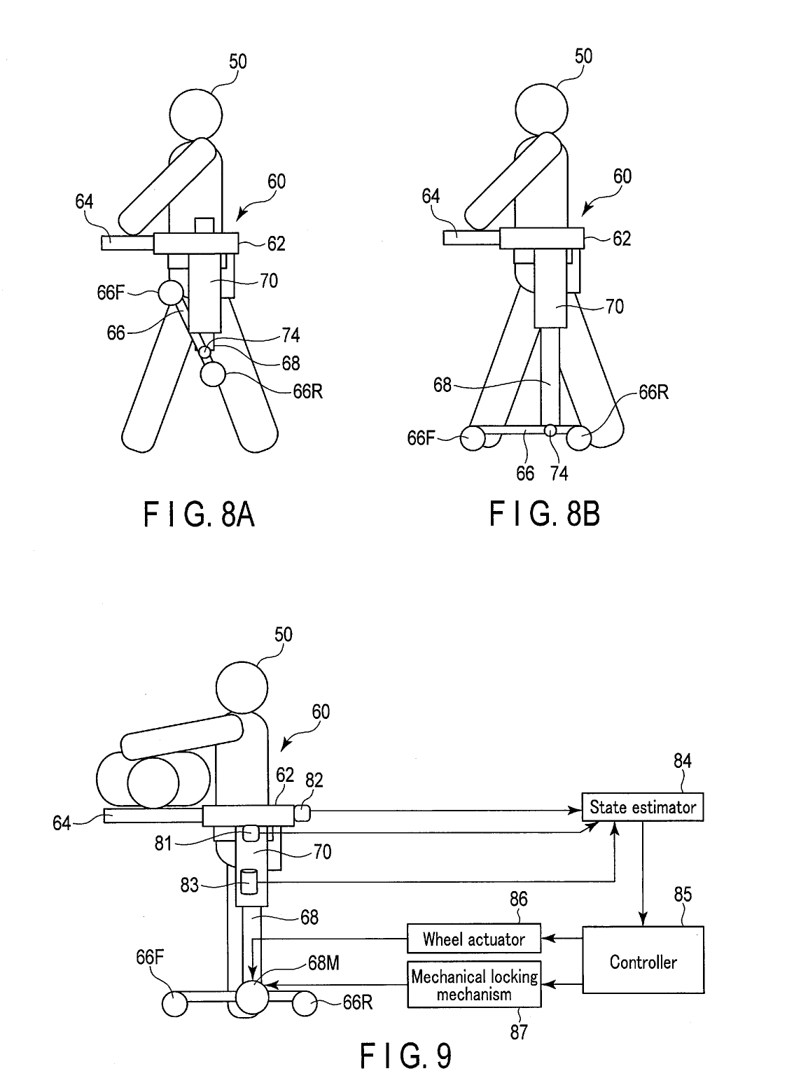

In the conveyance assisting device 60 of the present embodiment, the foot part 66 can be retracted in a compact form. FIG. 8A schematically shows the conveyance assisting device 60 in a state where the foot parts 66 are retracted, and FIG. 8B schematically shows the conveyance assisting device 60 in a state where the foot parts 66 are extended. As shown in FIG. 8A, the foot part 66 includes a front wheel 66F and rear wheel 66R, and is connected to one end of the support member 68 through the connecting part 74. The connecting part 74 is constituted of a rotary joint, and the foot part 66 rotates around a rotating shaft.

As shown in FIG. 8A, in the state where the foot part 66 is retracted, the support member 68 is shortened. The foot part 66 includes a spring (not shown) to add a turning force to the foot part 66 and, when no other force acts thereon, the foot part 66 is held in a posture in which the front wheel 66F of the foot part 66 is elevated by the spring. When transiting from the foot part retracted state shown in FIG. 8A to the foot part extended state shown in FIG. 8B, the user 50 extends the support member 68. For example, when the user operates a button, the drive unit 72 (FIG. 7A) moves the support member 68 in the downward direction. When the support member 68 is extended, first the rear wheel 66R comes into contact with the traveling surface. When the support member 68 is further extended, the foot part 66 rotates around the rotating shaft, and a state is brought about where the front wheel 66F is also in contact with the traveling surface. When this state is brought about, locking is made in such a manner that the turning force of the spring does not act on the foot part 66.

When transiting from the foot part extended state to the foot part retracted state, the user 50 shortens the support member 68. For example, when the user 50 operates a button, the drive unit 72 moves the support member 68 in the upward direction. When the support member 68 is shortened to a certain position, the locking is released, and the foot part 66 is held in a posture in which the front wheel 66F thereof is elevated by the force of the spring.

FIG. 9 is a block diagram schematically showing the conveyance assisting device 60 according to the second embodiment. The conveyance assisting device 60 shown in FIG. 9 includes wheels 66F, 66R, and 66M, wheel actuator 86 which rotationally drives at least one of the wheels 66F, 66R, and 66M, and mechanical locking mechanism 87 which locks at least one of the wheels 66F, 66R, and 66M. In the example shown in FIG. 9, the wheel actuator 86 and the mechanical locking mechanism 87 are connected to the wheel 66M.

The main body 62 includes an inclination sensor 81, and distance sensor 82. The inclination sensor 82 detects the inclination of the main body 62 relative to the traveling surface. The distance sensor 82 detects a distance between the main body 62 and the traveling surface. An output of the inclination sensor 81 and an output of the distance sensor 82 are sent to a state estimator 84. Furthermore, a laser scanner 83 which detects a position of the user 50 by scanning the horizontal plane may be included in the main body support part 70. An output of the laser scanner 83 is sent to the state estimator 84.

The state estimator 84 estimates a state of the user 50 on the basis of an output of at least one of the inclination sensor 81, distance sensor 82, and laser scanner 83. For example, the state estimator 84 determines whether the user 50 is working or is moving. A controller 85 controls the wheel actuator 86 and mechanical locking mechanism 87 based on the state estimated by the state estimator 84. For example, while the user 50 is working, the controller 85 controls the mechanical locking mechanism 87 to brake the wheel 66M. Thereby, it is possible to enable the device to move along the traveling surface during operation without disturbing the work underway. Also, while the user 50 is moving, the controller 85 carries out drive control of the wheel 66M to adjust to the walking speed of the user 50. This enables the user 50 to easily carry out conveyance/movement. Furthermore, when the positions of the user 50 and main body 62 deviate from each other, the controller 85 controls the wheel 66M to cancel out the deviation. Thus, the user 50 can be prevented from falling. As described above, while the user 50 is moving, it is possible to prevent the user 50 from falling, and carry out conveyance work more safely by utilizing the actuator 86 attached to the wheel 66M.

As described above, in the conveyance assisting device 60 according to the second embodiment, the pair of foot parts 66 is provided in such a manner that the foot parts 66 are positioned to the outer side the user 50. Thereby, the effect of preventing the user 50 from falling is further improved upon over the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A conveyance assisting device comprising:
a main body to be worn by a user;
an object support part connected to the main body, the object support part being used to support an object to be conveyed;
a main body support part supporting the main body;
a foot part connected to the main body support part, the foot part being movable along a traveling surface; and
a connecting part connecting the main body support part and the foot part to each other such that a position of the foot part relative to the main body support part is changed according to a direction and a magnitude of force acting on the main body support part.

2. The conveyance assisting device according to claim 1, wherein the connecting part connects the main body support part and the foot part to each other such that the position of the foot part relative to the main body support part is changed according to an inclination of the main body support part relative to the foot part.

3. The conveyance assisting device according to claim 1, further comprising an extension part to extend the foot part when the position of the foot part is to be changed.

4. The conveyance assisting device according to claim 1, wherein the foot part includes three or more wheels and is in contact with the traveling surface at the three or more wheels.

5. The conveyance assisting device according to claim 4, further comprising a wheel actuator to rotationally drive at least one of the three or more wheels.

6. The conveyance assisting device according to claim 5, further comprising:
an inclination sensor which detects an inclination of the main body support part relative to the foot part to generate a first detection signal;
a distance sensor which detects a distance between the main body and the traveling surface to generate a second detection signal; and
a state estimator which estimates a state of the user based on the first detection signal and the second detection signal.

7. The conveyance assisting device according to claim 6, further comprising a controller which controls the wheel actuator based on the state estimated by the state estimator.

8. The conveyance assisting device according to claim, 4 further comprising a mechanical locking mechanism to lock at least one of the three or more wheels.

9. The conveyance assisting device according to claim 4, wherein the conveyance assisting device is designed so that a state where the foot part is retracted in a posture in which a front wheel of the three or more wheels is elevated, and a state where the three or more wheels are in contact with the traveling surface are switched between each other.

10. The conveyance assisting device according to claim 1, further comprising a brake connected to the main body support part, the brake provided to come into contact with the traveling surface according to a direction and a magnitude of force acting on the main body support part.

11. The conveyance assisting device according to claim 10, wherein the brake comes into contact with the traveling surface according to an inclination of the main body support part relative to the foot part.

12. The conveyance assisting device according to claim 1, wherein the foot part comprises a first member, a second member, and a third member both of which are rotatably connected to one end of the first member, an elastic member provided between the second member and the third member to impart elastic force to the second member and the third member in a direction in which an angle formed between the second member and the third member is increased, and a guide to guide the second member and the third member such that the angle is changed according to the position of the foot part relative to the main body support part.

13. The conveyance assisting device according to claim 1, further comprising a drive unit which drives the main body support part such that the foot part is in contact with the traveling surface, wherein the main body support part comprises a first support member fixed to the main body, and a second support member supported by a first support member movable in a direction in which the first support member extends.

14. A conveyance assisting device comprising:
a main body to be worn by the user;
an object support part connected to the main body, the object support part being used to support an object to be conveyed;
a first main body support part supporting the main body;
a first foot part connected to the first main body support part, the first foot part being movable along a traveling surface;
a first connecting part connecting the first main body support part and the first foot part to each other such that a position of the first foot part relative to the first main body support part is changed according to a direction and a magnitude of force acting on the first main body support part;
a second main body support part supporting the main body, the second main body support part being provided opposite to the first main body support part;
a second foot part connected to the second main body support part, the second foot part being movable along the traveling surface; and
a second connecting part connecting the second main body support part and the second foot part to each other such that a position of the second foot part relative to the second main body support part is changed according to a direction and a magnitude of force acting on the second main body support part.
